(19) United States
(12) Patent Application Publication
(10) Pub. No.: US 2019/0229648 A1
(43) Pub. Date: Jul. 25, 2019

(54) PIEZOELECTRIC POWER APPARATUS

(71) Applicant: Edwin Steven Newman, Palmdale, CA (US)

(72) Inventor: Edwin Steven Newman, Palmdale, CA (US)

(21) Appl. No.: 15/877,135

(22) Filed: Jan. 22, 2018

(51) Int. Cl. H02N 2/18; F03B 17/06

(52) U.S. Cl. CPC H02N 2/185; F03B 17/06

(57) ABSTRACT

A piezoelectric power apparatus wherein waterproofed piezoelectric material is located within a water-filled container. Water pressure within the container is made to rapidly vary either by a cam operated piston rotated by a water turbine or a motor operated ball valve. A flowing water current is made to operate the ball valve which interrupts periodically the water flow, or the continuous water flow is made to operate the piston through the agency of a water turbine-operated cam.

This invention is a continuation-in-part of my patent application US2017-0366106.

### BACKGROUND OF THE INVENTION

In my patent application US2017-0366106 there is described a water-filled chamber with multiple inlet and outlet pipes, each containing a solenoid operated valve. The inlet pipes are operatively connected to a water source at a high elevation. The outlet pipes are operatively connected to a water reservoir at a lower elevation than the chamber. Opening and then closing each outlet and inlet pipe in succession produces waves of water pressure within the chamber. The solenoids are operated by a rotary electric switch operated in turn by a motor.

I have found the waves of pressure produced using solenoid operated valves are only about one or two Hertz. If waterproofed piezoelectric material within the chamber is to be made to produce electric power in a reasonable quantity electrical resistance within the material must be minimized. Therefor the area of the faces of the piezoelectric material must be greatly increased and the thickness made very small. These requirements increase the cost of manufacturing the invention.

### SUMMARY OF THE INVENTION

There is presented a closed container filled with water and containing piezoelectric material connected to the electric grid. Filling a hole in a wall of the container is a piston capable of pressurizing and depressurizing the water in the container as well as the enclosed piezoelectric material, producing electric power.

The piston is activated either hydrodynamically by the rotating of a ball valve which regularly is made to interrupt the flow of a fluid, or mechanically as when the piston is operated by a cam attached and operated by a turbine located in a fluid stream.

The aim of the present invention is to increase the frequency of the pressure waves to decrease the amount of piezoelectric material needed to produce the same amount of electric power.

### BRIEF DESCRIPTION OF THE DRAWINGS

FIG. 1 is a perspective view of the First Preferred Embodiment.

FIG. 2 is a perspective view of the Second Preferred Embodiment.

### DETAILED DESCRIPTION OF THE TWO PREFERRED EMBODIMENTS

### First Preferred Embodiment

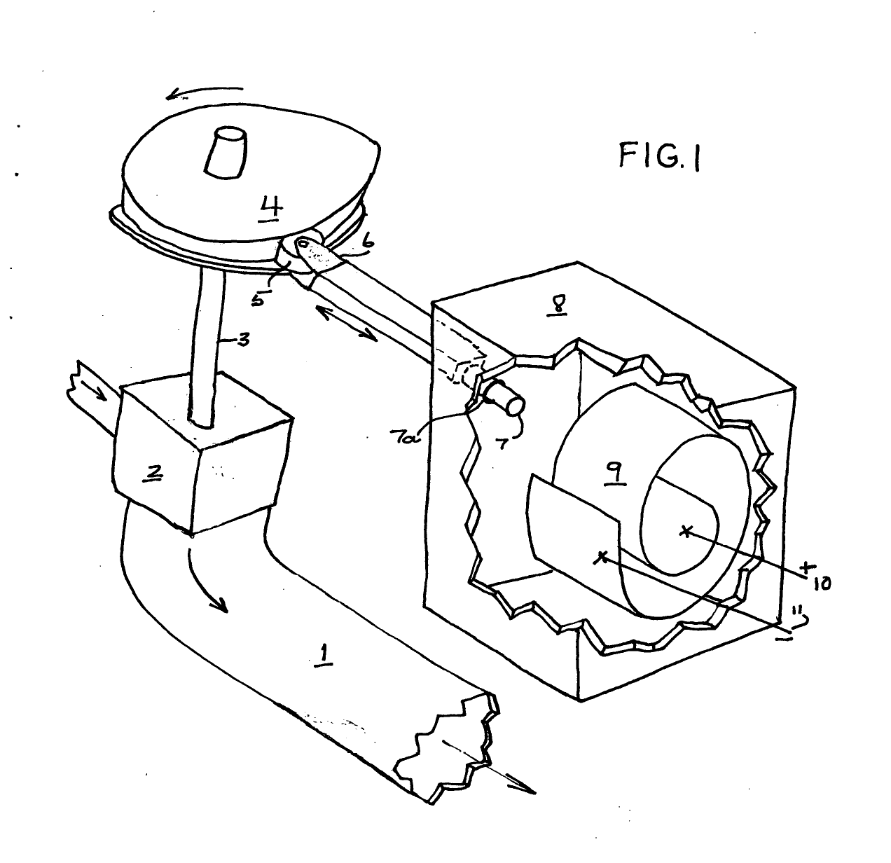

Turning to FIG. 1 we see a turbine 2 is operatively connected to fluid in fluid pipe 1. A cam 4 is in turn operatively connected to turbine 2 through the agency of shaft 3. Bracket 6 holds wheel 5 in place and is fixedly attached to piston 7. Wheel 5 is located so its outer rim is operatively connected to the outer rim of cam 4. O-ring 7a is located circumferentially around piston 7 to prevent fluid within container 8 from leaking through the hole through which piston 7 is made to enter the interior of container 8 which is made to contain piezoelectric material 9. Electric leads 10,11 are led from either side of piezoelectric material (shown in the form of a sheet) 9 through a wall of container 8 and on to the grid. The liquid within container 8 may be a dielectric such as purified water. If the liquid is not a dielectric then piezoelectric material 9 must be electrically insulated from the fluid by, for example, a rubber envelope.

In operation, fluid made to flow through pipe 1 causes turbine 2 and cam 4 to revolve and cause piston 7 to move back and forth, which causes the liquid within container 8 as well as the surfaces of piezoelectric material 9 to be alternately pressurized and depressurized. The resulting power output is taken off by leads 10, 11.

### Second Preferred Embodiment

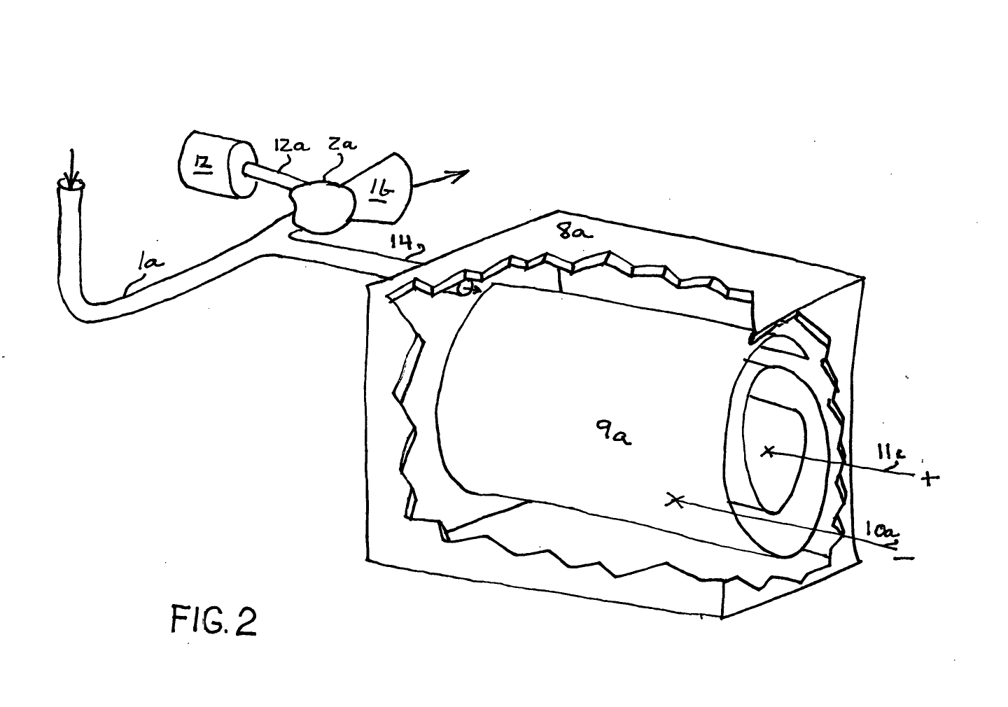

In FIG. 2 we see ball valve 2a is operatively connected to fluid made to flow through pipe 1a, 1b. Motor 12 is operatively connected to ball valve 2a through the agency of shaft 12a. Pipe 14 is made to branch off from pipe section 1a. The other end of pipe 14 is operatively connected to container 8a which is made to contain piezoelectric material 9a . Electric leads 10a, 11a are led from either side of piezoelectric material 9a through a wall of container 8a and on to the grid. The liquid within container 8a may be a dielectric such as purified water. If the liquid id not a dielectric then piezoelectric material 9a must be electrically insulated from the fluid by, for example, a rubber envelope.

In operation, pressurized fluid is made to flow intermittently through ball valve 2a as it is made to open and close by operating motor 12. As tube 14 operatively connects pipe 1a and container 8a the pressure on piezoelectric material 9a is made to vary at a rate dependent on the rate at which ball valve 2a is made to revolve. The resultant power output is taken off by leads 10a, 11a.

From the above descriptions it is apparent that the preferred embodiments achieve the object of the invention. Alternative embodiments and various depictions of the present embodiments will be apparent to those skilled in the art.

I claim:

1. An energy conversion apparatus comprising:
a. a pipe filled with pressurized water,
b. means for rapidly varying water pressure within said pipe selected from the group of:
1. a ball valve within said pipe, and
2. a turbine within said pipe shafted to a cam operably connected to a piston,
c. a water-filled container operably connected to said pressurized water through said means and containing piezoelectric material electrically connected to the grid,
so as water is made to flow through said pipe, then water pressure within said container is made to vary and cause said piezoelectric material to generate electric power.

2. The apparatus of claim 1 wherein said pipe is made to branch off, said pipe branch made to extend from said pipe at a place between the inlet of said pipe and said ball valve through a wall of said container.

3. The apparatus of claim 1 wherein said piston is operably connected to said cam through the agency of a wheel arranged to ride on the rim of said cam as said cam is made to revolve.

4. The apparatus of claim 1 wherein said fluid within said container is purified water.

5. The apparatus of claim 1 wherein said piezoelectric material is waterproofed by a rubber envelope.
